(19) United States
(12) Patent Application Publication
(10) Pub. No.: US 2009/0037242 A1
(43) Pub. Date: Feb. 5, 2009

(54) System for Monitoring Periodic Processing of Business Related Data

(75) Inventors: Matthew Ventura, Boothwyn, PA (US); Tathagata Haldar, Pottstown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/116,278

(22) Filed: May 7, 2008

Related U.S. Application Data
(60) Provisional application No. 60/952,645, filed on Jul. 30, 2007.

(51) Int. Cl. G06Q 10/00

(52) U.S. Cl. 705/7

(57) ABSTRACT

A system stores and analyzes task processing statistical data and adaptively calculates the overall completion time of day-end processing of a set of standard jobs that create reports that need to be run at the end of each business day, for example, to extract and summarize key business data. In response different processing loads and task execution times occurring on different days. A system for monitoring periodic processing of business related data to provide reports at day end and other times, includes a repository of information. The information identifies multiple measured time durations required for processing business related data to provide a corresponding plurality of reports for individual days of multiple days. A computation processor determines an average time duration for processing business related data to provide an individual report by averaging measured time durations required for processing data to provide the individual report over multiple days. The computation processor uses the average time duration, together with a reference time of processing, to provide a predicted time of completion of processing to provide the individual report. A communication processor provides result data to a user. The result data represents the predicted time of completion of processing to provide the individual report.

This is a non-provisional application of provisional application Ser. No. 60/952,645 filed Jul. 30, 2007, by M. Ventura et al.

### FIELD OF THE INVENTION

This invention concerns a system for monitoring periodic processing of business related data to provide reports at day end and other times by providing a predicted time of completion of processing to provide individual reports.

### BACKGROUND OF THE INVENTION

In a computer data processing system that processes data at the end of a business day, for example, it is typical for additional operational tasks to be performed after the completion of day-end processing using the day-end processing results. Known systems typically involve manual maintenance of a spreadsheet for use in estimating average executable task completion times and update the spreadsheet as each task completes. This is labor-intensive and prone to human error. Known systems lack knowledge of when day-end processing is to be complete and are consequently unable to optimize use of processing and other resources dependent on this completion. One known system provides prediction on a task level basis. This prediction uses a predicted end time of a task to allocate Central Processing Unit or (CPU) resources to late running tasks to keep the overall flow consistent. Therefore, if a task is running behind schedule, the system notices the delay and places resource emphasis on the slow running task which ultimately keeps the day-end flow consistent with its prior runs. This system fails to provide an overall prediction of a day-end process and fails to adaptively calculate a month end task run differently from a normal day-end run to provide a more accurate prediction, for example. A system according to invention principles addresses these deficiencies and related problems and enables a computer operations department to optimize resources based on a predicted task processing completion time.

### SUMMARY OF THE INVENTION

A system stores and analyzes task processing statistical data and calculates the overall completion time of day-end processing of a set of standard reports, of varying execution time, that need to be run at the end of each business day to extract and summarize key business data. A system for monitoring periodic processing of business related data to provide reports at day end and other times, includes a repository of information. The information identifies multiple measured time durations required for processing business related data to provide a corresponding plurality of reports for individual days of multiple days. A computation processor determines an average time duration for processing business related data to provide an individual report by averaging measured time durations required for processing data to provide the individual report over multiple days. The computation processor uses the average time duration, together with a reference time of processing, to provide a predicted time of completion of processing to provide the individual report. A communication processor provides result data to a user. The result data represents the predicted time of completion of processing to provide the individual report.

### BRIEF DESCRIPTION OF THE DRAWING

FIG. 1 shows a system for monitoring periodic processing of business related data to provide reports at day end and other times, according to invention principles.

FIG. 2 shows a flowchart of a process used to predict completion time of processing of executable tasks on a normal (non-special) day, according to invention principles.

FIG. 3 shows code for implementing the process of FIG. 2, according to invention principles.

FIG. 4 shows a flowchart of a process used to predict completion time of processing of executable tasks on a special day, e.g., a month-end day, according to invention principles.

FIG. 5 shows code for implementing the process of FIG. 4, according to invention principles.

FIG. 6 illustrates status of prediction of completion of day end report generation processing during the day displayed on a website which allows support staff to monitor multiple day-end processes from one central location, according to invention principles.

FIG. 7 illustrates status of prediction of completion of day end report generation processing during day end operation (e.g., after midnight) displayed on a website, according to invention principles.

FIG. 8 illustrates a time line of day end processing streams individually comprising one or more tasks, according to invention principles.

FIG. 9 shows a flowchart of a process performed by a system for monitoring periodic processing of business related data to provide reports at day end and other times, according to invention principles.

### DETAILED DESCRIPTION OF THE INVENTION

A system according to invention principles employs a software execution task prediction process that queries statistical data from a user Online Analytical Processing (OLAP) database and predicts a completion time of a day-end process. The day-end process comprises execution of job scheduling software to generate a set of standard reports, of varying execution time, that need to be run at the end of each business day to extract and summarize key business data. The system adaptively calculates a prediction of a completion time of processing of special tasks such as month-end report generation execution processing differently than non-special (e.g., normal business day report generation processing) to provide a more accurate prediction. Month-end report generation execution processing typically includes generation of more and/or bigger reports involving more execution processing and time, for example. The system stores and analyzes task processing statistical data and calculates the overall completion time of day-end and month-end processing. The day-end processing flow is not always the same, so the system determines which day-end flow is being performed and executes the correct logic accordingly. The results of the prediction of completion time of processing are displayed on a website which allows support staff to monitor day-end processes at one central location.

In operation, the completion time of a current report generation task that has completed successfully is acquired from statistical data stored in a database. The end date & time of the completed current report generation task is averaged for the prior 21 days. In addition the completion date and time of a last report generation task which executed on individual days in a day-end process, is acquired for the prior n days, which is user defined and is averaged. The difference in completion time is taken between the current report generation task average and the final report generation task average. The difference between the two is used to estimate completion time of a current day-end process. In one embodiment, if a current report generation task completion time computation encompasses a month-end, the day end processing indicated above is followed except that the average time for a month-end current report generation task in the day end task flow is averaged across the prior 12 month end days. Also, the last report generation task on a month-end day is averaged across the prior 12 month-end days. These averaged values are used in the day-end task and process completion time prediction. This provides a more accurate prediction that accommodates report generation task execution during the month end flow.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

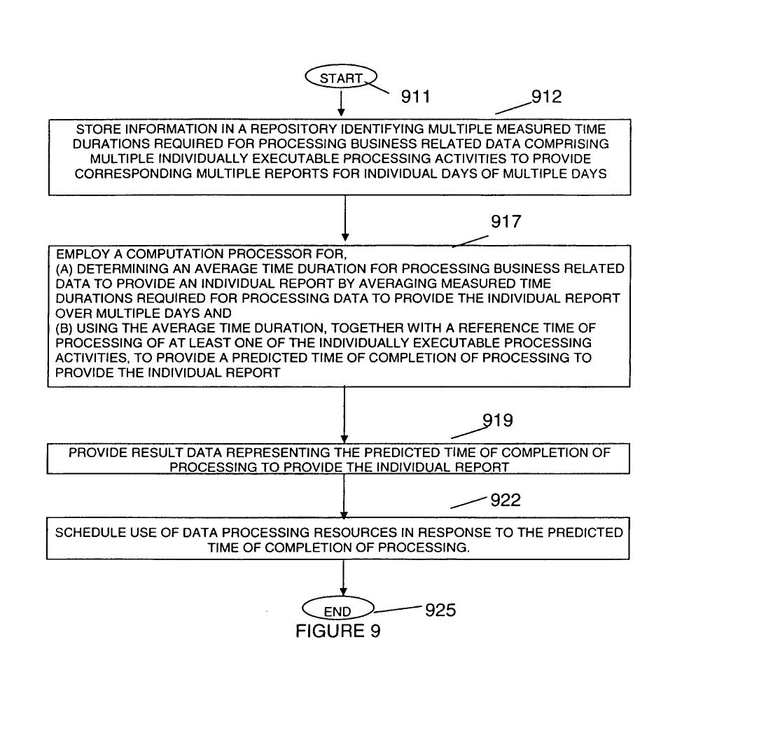

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 9) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A task scheduler (also known as a workflow processor), as used herein, processes data to schedule tasks for execution at a particular time or for execution following completion of a previous task in a task sequence (workflow), determines tasks to add to a task list, remove from a task list or modifies tasks incorporated on, or for incorporation on, a task list. A task list is a list of tasks for performance by a device. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and for updating task lists of a device to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

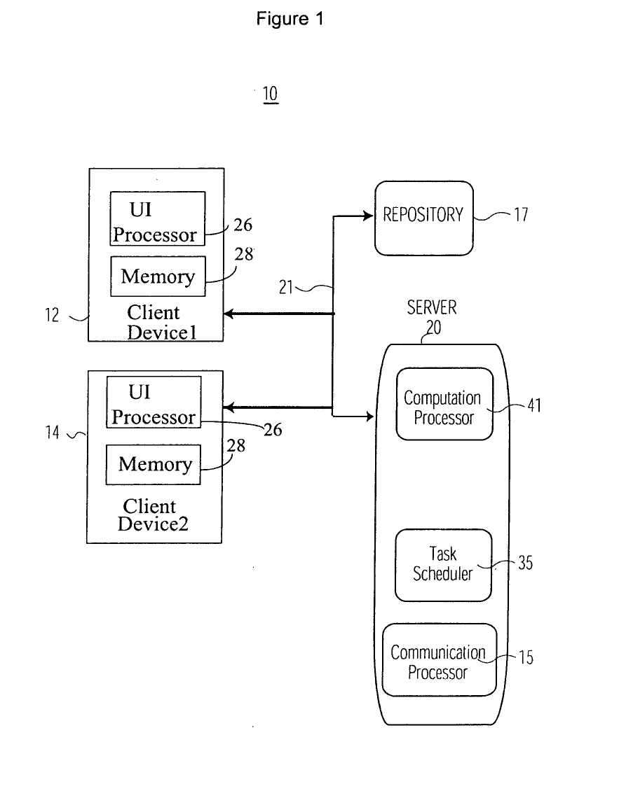

FIG. 1 shows system 10 for monitoring periodic processing of business related data to provide reports at day end and other times. System 10 includes client devices (e.g. workstations, note books, Personal Digital Assistants, cell phones) 12 and 14, at least one repository 17 and server 20 inter-communicating via network 21. Server 20 includes communication processor 15, task scheduler 35 and computation processor 41. Client devices 12 and 14 individually include memory 28 and display processor 26. Display processor 26 provides data representing display images for presentation on client device 12 and 14.

At least one repository 17 includes information identifying multiple measured time durations required for processing business related data to provide corresponding multiple reports for individual days of multiple days. Computation processor 41 determines an average time duration for processing business related data to provide an individual report by averaging measured time durations required for processing data to provide the individual report over multiple days. Computation processor 41 uses the average time duration, together with a reference time of processing, to provide a predicted time of completion of processing to provide the individual report. Communication processor 15 provides result data to a user, the result data representing the predicted time of completion of processing to provide the individual report.

Computation processor 41 employs a software execution task prediction process that is used to predict (estimate) an overall completion time of day-end business data processing flow as well as to predict completion time of individual tasks. A task comprises report generation, for example. For this purpose computation processor 41 acquires historical task data used in calculating average day-end business processing completion time from repository 17. Further, in response to a user accessing and entering commands via a day-end processing website, system 10 predicts a day-end business processing completion time for individual different environments (i.e., for individual user information databases) and a predicted time to completion is calculated by computation processor 41 from a particular time in a day until day-end processing is completed. System 10 provides a snapshot prediction for completion of day-end processing, for example. If the website is accessed and prediction of day-end business processing completion time is initiated an hour later, for example, the prediction changes because a different current report generation task (of a stream of executable tasks) is being executed. Thereby the system provides a dynamically variable prediction.

In system 10 operation, Task x is a Current Task and Task y is a Last Task. A Current Task is one that is recorded last in a database table and a Current Task is recorded in the database table when it is either, successfully completed, or forcefully marked as complete due to failure, for example. A Last Task is a task that completes business report generation at the end of a day, for example, and is the final task to execute in the business report generation end of day task flow. In exemplary operation, Task x completion time is averaged over the prior user defined days (e.g. previous 60 days) and is 1:30 AM. Task y completion time is averaged over the prior user defined days (e.g. previous 60 days) and is 10:00 AM so the difference of Task x and Task y is 8.5 hrs. Therefore, 8.5 hours is added to an actual completion time of Task x. For example, Task x finished at 2 AM because of a delay, so that computation processor 41 determines a predicted completion time of day-end business report generation is 10:30 AM.

System 10 dynamically determines if a stream (a sequence) of execution tasks varies. If a stream of tasks comprises tasks, x, u, v, w, y some days and x, u, v, w, z, y other days, system 10 accommodates the task variation by adding or subtracting a particular task average (e.g., an average execution time of task z in this example). Thereby system 10 dynamically compensates a predicted completion time of day-end business report generation for occurrence of an additional task or an omitted task in a task stream comprising the business report generation.

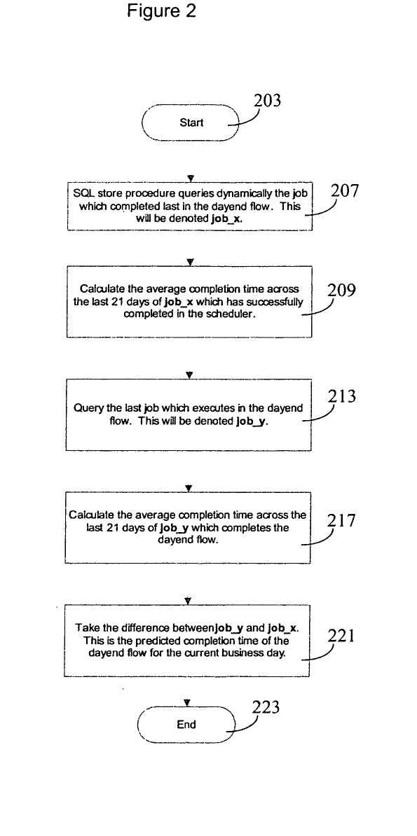

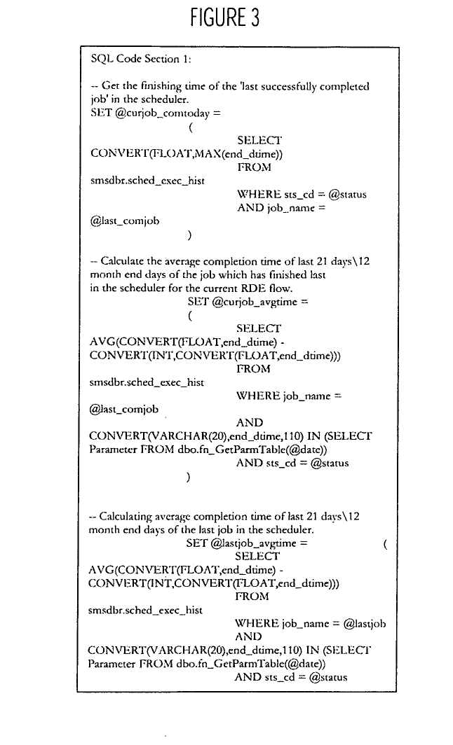

FIG. 2 shows a flowchart of a process used to predict completion time of business report generation processing of executable tasks on a normal (non-special) day by system 10 (FIG. 1). Specifically FIG. 2 shows a flowchart of a process employed by a stored procedure written in the Transact-SQL language, for example, used by computation processor 41 (FIG. 1) that implements logic to predict a completion of day-end business report generation processing. In step 207, following the start at step 203, an SQL procedure is used by computation processor 41 to dynamically query repository 17 to identify completion times of a Current Task (Task x) for the prior user defined days (e.g. prior 21 days). In step 209, computation processor 41 uses the SQL procedure and data acquired from repository 17, to average completion times of successfully completed Current Tasks over the prior user defined days. In step 213, the SQL procedure is used by computation processor 41 to dynamically query repository 17 to identify completion times of a Last Task (Task y) for the prior user defined days. In step 217, computation processor 41 uses the SQL procedure and data acquired from repository 17, to average completion times of Last Tasks over the prior user defined days. In step 221, computation processor 41 determines the difference of the averaged Task x and Task y and provides a predicted completion time of day-end business report generation. The predicted completion time of processing is determined by adding the difference to a completion time of a current Task x. The process of FIG. 2 terminates at step 223. FIG. 3 illustrates Transact-SQL language code for implementing the process of FIG. 2.

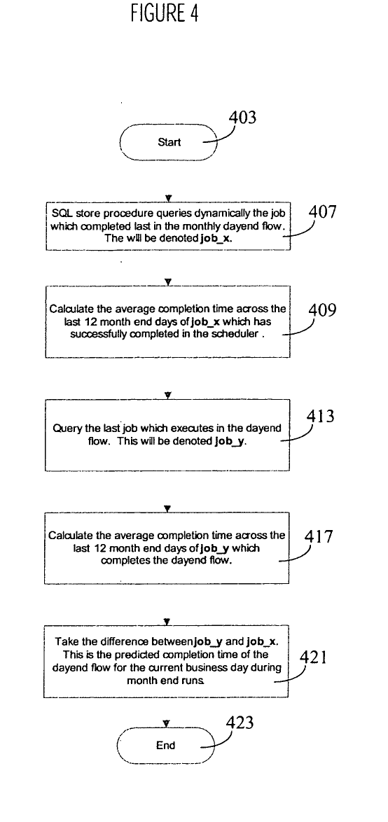

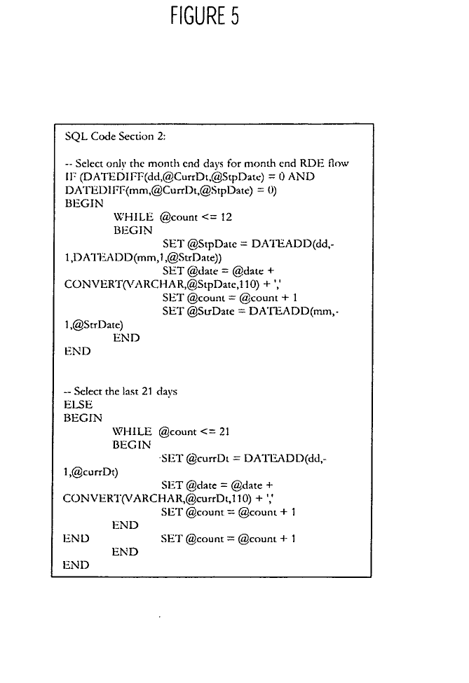

There are other types of the day-end flow. For example there is month-end business report generation processing. Month-end business report generation processing executes during the last day of each month. System 10 dynamically accommodates increase in number and duration of tasks that execute at month-end. If computation processor 41 used the process of FIG. 2 for month-end business report generation processing, it would return inconsistent results, since month-end tasks typically take longer. In order to keep day-end business report generation completion time prediction stable during month-end processing, logic is used to determine whether the current day-end flow is a normal flow or month-end flow (as illustrated in the code of FIG. 5). If computation processor 41, in executing the code of FIG. 5, determines that month-end business report generation completion time prediction is being performed, processor 41 performs the logic and process shown in FIG. 4 to determine a business report generation predicted completion time.

FIG. 4 shows a flowchart of a process used to predict completion time of processing of executable tasks on a special, e.g., month-end day by system 10. Specifically, FIG. 4 shows a flowchart of a process employed by a stored procedure written in the Transact-SQL language, for example, used by computation processor 41 that implements logic to predict a completion of day-end business report generation processing. In step 407, following the start at step 403, an SQL procedure is used by computation processor 41 to dynamically query repository 17 to identify completion times of a Current Task (Task x) for the prior 12 month-end days. In step 409, computation processor 41 uses the SQL procedure and data acquired from repository 17, to average completion times of successfully completed Current Tasks over the prior 12 month-end days. In step 413, the SQL procedure is used by computation processor 41 to dynamically query repository 17 to identify completion times of a Last Task (Task y) for the prior 12 month-end days. In step 417, computation processor 41 uses the SQL procedure and data acquired from repository 17, to average completion times of Last Tasks over the prior 12 month-end days. In step 421, computation processor 41 determines the difference of the averaged Task x and averaged Task y and provides a predicted completion time of 12 month-end day-end business report generation. The predicted completion time of processing is determined by adding the difference to a completion time of a current Task x. The process of FIG. 4 terminates at step 423. FIG. 5 illustrates Transact-SQL language code for implementing the process of FIG. 4.

The results of a predicted completion time of day-end business report generation are advantageously incorporated into a website for use by operations staff. The website is a central location advantageously usable to monitor different environments executing day-end business report generation processing applications. When a web page is accessed by a user login to individual environment OLAP databases, system 10 computation processor 41 executes a stored executable procedure to provide a completion time of business report generation processing, for example, associated with the individual environment. Computation processor 41 executes the stored executable procedure and provides, a name of the environment and the predicted or actual completion time of, a completed task or day-end business report generation process for display in an image window associated with the environment in a web page of the web site using display processor 26. System 10 employs a visual attribute such as color coding as well as text in a web page display to highlight potential problems associated with status of an individual environment.

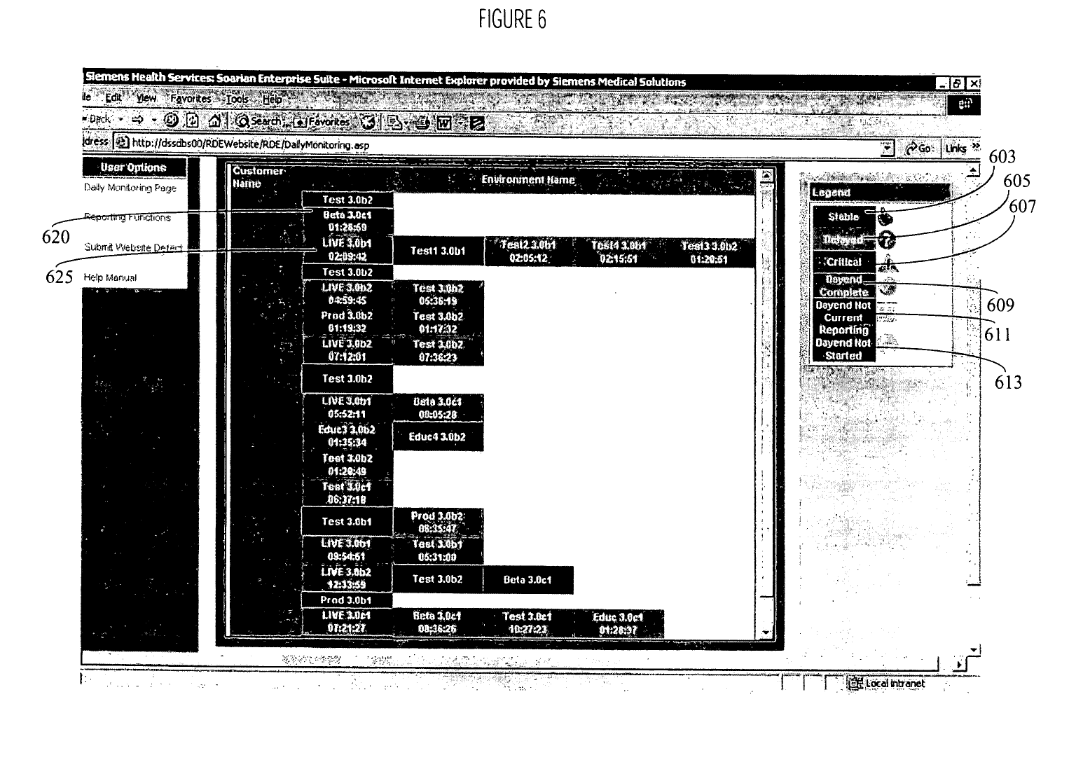

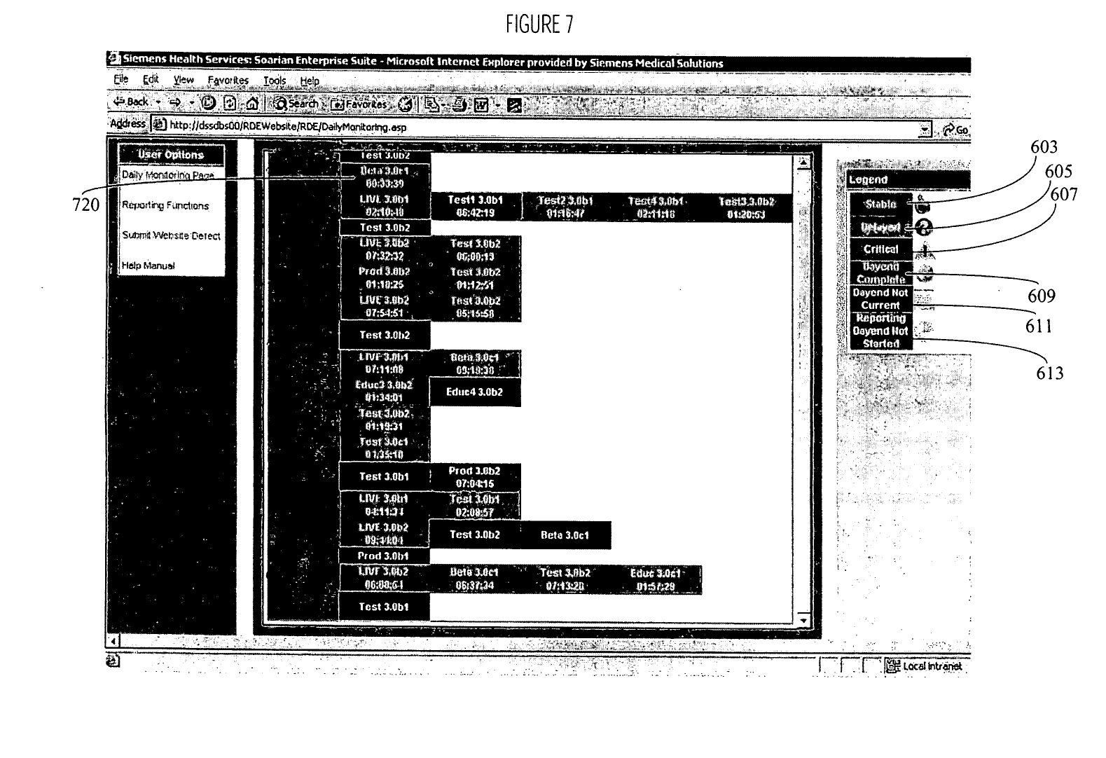

FIG. 6 illustrates status of prediction of completion of day end report generation processing during the day displayed on a website which allows support staff to monitor day-end processes from a central location. Similarly, FIG. 7 illustrates status of prediction of completion of day end report generation processing during day end operation (e.g., after midnight) displayed on a website. In FIGS. 6 and 7, an individual row is associated with an individual customer and includes one or more boxes that represent one or more business report generation task execution (environments) of the individual customer. Text presented in a box indicates the type of customer environment (such as TEST, BETA, PROD=production, EDU=education, or LIVE) and also indicates a version of software the environment is running on (e.g., 3.0b2, c1, c2 . . . etc . . . ). The box text also indicates a time at which business report generation day-end processing has completed or is predicted to complete.

Tasks (environments) are coded by visual attribute such as cross-hatching, shading, color, text or other visual attribute. Specifically, individual task and day-end report generation completion time condition status are indicated by visual highlighting in FIGS. 6 and 7. Stable status 603 is shown by a first cross-hatching pattern, or color Green, for example, and indicates day-end business report generation processing is predicted to complete on time or ahead of a normal day-end 21, or month-end 12, day average completion time. Delayed status 605 is shown by a second cross-hatching pattern, or color Yellow, for example, and indicates day-end business report generation processing is predicted to complete one hour or less behind the normal day-end 21, or month-end 12, day average completion time. Critical status 607 is shown by a third cross-hatching pattern, or color Red, for example, and indicates day-end business report generation processing is predicted to complete 2 or more hours behind the normal day-end 21, or month-end 12, day average completion time. DayEnd Complete status 609 is shown by a fourth cross-hatching pattern, or color Light Blue, for example and indicates the Last Task to execute in day-end business report generation processing task flow has completed successfully. DayEnd Not Current status 611 is shown by a fifth cross-hatching pattern, or color Black, for example, and indicates that day-end business report generation processing has not run for 1 or more days. Reporting DayEnd Not Started status 613 is shown by a sixth cross-hatching pattern, or color Violet, for example.

Row 620 of FIG. 6, for example shows task execution environments for customer A. Specifically, for customer A. Test task execution environment version 3.0b2 has DayEnd Not Current status (i.e. this task execution is not being performed) and Beta task execution environment 3.0c1 day-end processing completed at 01:26:59. Row 625 of FIG. 6, shows task execution environments for customer B. Specifically, for customer B, Live task execution environment version 3.0b1 day-end processing completed at 02:09:42, Test1 task execution environment version 3.0b1 has DayEnd Not Current status, Test2 task execution environment version 3.0b1 day-end processing completed at 02:05:12, Test4 task execution environment version 3.0b1 day-end processing completed at 02:15:51, and Test3 task execution environment version 3.0b2 day-end processing completed at 01:20:51. Row 720 of FIG. 7, for example shows task execution environments for customer C. Specifically, for customer C, Test task execution environment version 3.0b2 has DayEnd Not Current status (i.e. this task execution is not being performed) and Beta task execution environment 3.0c1 day-end processing has Stable status and is predicted to complete at 00:33:39 on time or ahead of a normal day-end 21, or month-end 12, day average completion time. A user may advantageously select (e.g., click-on) any of the displayed boxes to initiate generation of an image window containing detailed information of the customer environment concerned and its operation.

System 10 adapts to different day-end scenarios, such as normal-end or month-end, and queries repository 17 for corresponding task completion time data to provide an accurate prediction time. System 10 employs logic to detect efficiency improvements that make day-end tasks execute faster over time. This logic dynamically changes the number of days averaged, so that system efficiency improvements do not affect average predicted completion time. System 10 automatically improves prediction logic and automatically compensates for abended (failed) tasks. Repository 17 includes a data table, for example, that is queried by computation processor 41 to obtain statistical data for a task and the table is written to and updated when a task has completed successfully or when the task has failed and been forcefully marked as complete. Therefore, if a task fails, the business report generation completion time prediction performed by processor 41 automatically compensates for the delay time period associated with the failure. System 10 also compensates for a Week-End day flow. During day-end processing at the end of a week, additional processing streams execute that contain one or more tasks and this extends normal (i.e., not week-end or month-end) processing time. System 10 automatically identifies and compensates for week-end processing as previously described in connection with additional or reduced number of tasks being processed. In performing week-end processing, system 10 queries repository 17 to acquire statistical data for days when week end processing executes and uses the statistical data in averaging task processing time in a similar manner to the way month-end processing is performed. This makes the prediction time for week-end flow provided by the system more accurate. Further, the system website supports user processing operation monitoring and predicts an entire day-end business report generation flow and automatically provides a report indicating abends (errors) which are unsolved in a processing period.

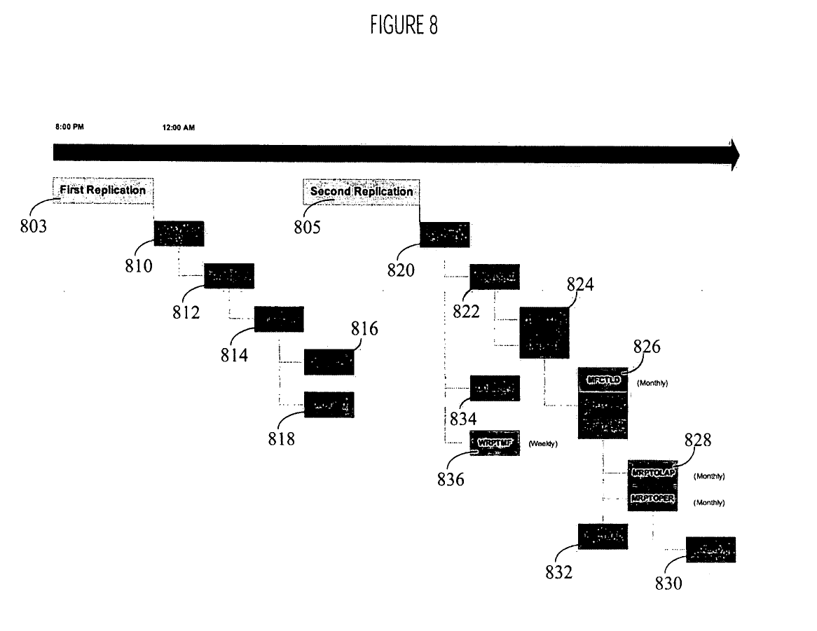

FIG. 8 illustrates a time line of day-end processing streams individually comprising one or more tasks. Business report generation involves execution of a set of streams of tasks each night, for example. A stream holds either one task or many tasks and may have predecessor streams and tasks can have predecessor tasks. FIG. 8 shows a time line of day-end flow of different day-end processing streams 803 and 805 that comprise multiple individual streams. Day-end processing stream 803 comprises individual streams 810, 812, 814, 816 and 818. Day-end processing stream 805 comprises individual streams 820, 822, 824, 834 and if month-end processing is occurring, it includes streams 826, 828, 830 and 832. Day-end processing stream 805 also includes individual stream 836 if week-end processing is occurring. System 10 identifies and acquires month-end processing data from repository 17 in performing month-end processing on the last day of each month. System 10 acquires statistical data from repository 17 for the month ends occurring during the prior year and excludes such month end anomalous data from day-end processing. Also, the system provides accurate prediction times for month-end days by averaging exclusively month end data processing.

FIG. 9 shows a flowchart of a process performed by system 10 (FIG. 1) for monitoring periodic processing of business related data to provide reports at day end and other times. In step 912 following the start at step 911, computation processor 41 stores information in repository 17. The information identifies multiple measured time durations required for processing business related data comprising multiple individually executable processing activities to provide corresponding multiple reports for individual days of multiple days. The processing business related data comprises multiple individually executable processing activities that comprise multiple individually executable tasks.

In step 917, computation processor 41 determines an average time duration for processing business related data to provide an individual report by averaging measured time durations required for processing data to provide the individual report over multiple days. Computation processor 41 uses the average time duration, to ether with a reference time of processing of at least one of the individually executable processing activities, to provide a predicted time of completion of processing to provide the individual report. The average time duration comprises an arithmetic mean or a median value and the reference time comprises, a start time of processing, a termination time of processing of at least one of the individually executable processing activities or a time associated with a known processing completion status. The computation processor combines the average time duration with the reference time to determine the predicted time of completion

Computation processor 41 dynamically compensates for variation in the number of the multiple individually executable processing activities in providing a predicted time of completion of processing by adding or subtracting an average processing time associated with a processing activity that is intermittently executed on days of the multiple days. The multiple days comprise at least one of, (a) between a week and a month, (b) a month, (c) a plurality of months and (d) two or more days. Further, computation processor 41 determines whether the multiple days associated with determining the average time duration encompasses an event associated with an exceptional data processing burden. In response to such a determination, computation processor 41 excludes a measured time duration associated with the event from use in determining the average time duration. The event associated with the exceptional data processing burden comprises at least one of, (a) week end processing, (b) month end processing, (c) quarter end processing and (d) year end processing and the year end processing comprises calendar or financial year end processing.

Communication processor 15, in step 919, provides result data representing the predicted time of completion of processing to provide the individual report to a user enabling the user to identify whether the predicted time of completion indicates a potential processing problem is occurring. Communication processor 41 provides multiple result data items showing a trend in the result data. In step 922 task scheduler 35 schedules use of data processing resources in response to the predicted time of completion of processing. The process of FIG. 9 terminates at step 825.

The systems and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system prediction of a processing time is usable by any process that tends to repeat but has variability in its duration of processing based on factors such as the amount of data or competition for resources with other processes (e.g. computer server resources shared with other processes). If statistical data is collected in a database, the system may be applied to the collected data. One example is a delivery vehicle that runs the same route each day but has variability based on traffic conditions and volume of packages being delivered. If statistics are captured at standard checkpoints via a computer device, the completion of the entire delivery route may be predicted. The system employs a graphical user interface to monitor day-end flow across multiple environments. The processes and applications may in alternative embodiments, be located on one or more (e.g., distributed) processing devices accessing a network linking the elements of FIG. 1. Further, any of the functions and steps provided in FIGS. 1-9 may be implemented in hardware, software or a combination of both and may reside on one or more processing devices located at any location of a network linking the elements of FIG. 1 or another linked network including the Internet.

What is claimed is:

1. A system for monitoring periodic processing of business related data to provide reports at day end and other times, comprising:
a repository of information identifying a plurality of measured time durations required for processing business related data to provide a corresponding plurality of reports for individual days of a plurality of days;
a computation processor for,
(a) determining an average time duration for processing business related data to provide an individual report by averaging measured time durations required for processing data to provide said individual report over a plurality of days and
(b) using said average time duration, together with a reference time of processing, to provide a predicted time of completion of processing to provide said individual report; and
a communication processor for providing result data to a user, said result data representing said predicted time of completion of processing to provide said individual report.

2. The system according to claim 1, wherein
said reference time comprises at least one of, (a) a start time of processing and (b) a termination time of processing and
said computation processor combines said average time duration with said reference time to determine said predicted time of completion.

3. The system according to claim 1, wherein
said processing business related data comprises a plurality of individually executable processing activities and
said reference time comprises at least one of, (a) a start time of processing and (b) a termination time of processing of at least one of said individually executable processing activities.

4. The system according to claim 1, wherein
said computation processor dynamically compensates for variation in said number of said plurality of individually executable processing activities in providing a predicted time of completion of processing by adding or subtracting an average processing time associated with a processing activity that is intermittently executed on days of said plurality of days.

5. The system according to claim 1, wherein
said reference time comprises a time associated with a known processing completion status.

6. The system according to claim 1, wherein
said computation processor determines whether said plurality of days associated with determining said average time duration encompasses an event associated with an exceptional data processing burden and in response to such a determination, said computation processor excludes a measured time duration associated with said event from use in said determining said average time duration.

7. The system according to claim 6, wherein
said event associated with said exceptional data processing burden comprises at least one of, (a) week end processing, (b) month end processing, (c) quarter end processing and (d) year end processing.

8. The system according to claim 7, wherein
said year end processing comprises calendar or financial year end processing.

9. The system according to claim 1, wherein
said communication processor provides said result data to said user enabling said user to identify whether said predicted time of completion indicates a potential processing problem is occurring.

10. The system according to claim 9, wherein
said communication processor provides a plurality of result data items showing a trend in said result data.

11. The system according to claim 1, including
a task scheduler for scheduling use of data processing resources in response to said predicted time of completion of processing.

12. The system according to claim 1, wherein
said average time duration comprises at least one of, (a) an arithmetic mean and (b) a median.

13. The system according to claim 1, wherein
said plurality of days comprises at least one of, (a) between a week and a month, (b) a month, (c) a plurality of months and (d) two or more days.

14. A system for monitoring periodic processing of business related data to provide reports at day end and other times, comprising:
a repository of information identifying a plurality of measured time durations required for processing business related data comprising a plurality of individually executable processing activities to provide a corresponding plurality of reports for individual days of a plurality of days;
a computation processor for,
(a) determining an average time duration for processing business related data to provide an individual report by averaging measured time durations required for processing data to provide said individual report over a plurality of days and
(b) using said average time duration, together with a reference time of processing of at least one of said individually executable processing activities, to provide a predicted time of completion of processing to provide said individual report; and
a communication processor for providing result data to a user, said result data representing said predicted time of completion of processing to provide said individual report.

15. The system according to claim 14, wherein
said plurality of individually executable processing activities comprises a plurality of individually executable tasks.

16. The system according to claim 14, wherein
said reference time comprises at least one of, (a) a start time of processing and (b) a termination time of processing of at least one of said individually executable processing activities.
